(19) United States
(12) Patent Application Publication
(10) Pub. No.: US 2025/0345800 A1
(43) Pub. Date: Nov. 13, 2025

(54) Modular Tube Rack

(71) Applicant: Foundation Medicine, Inc., Cambridge, MA (US)

(72) Inventors: Megan Yiyi Uozumi, San Diego, CA (US); Sabrina Ranee Reilly, San Diego, CA (US)

(21) Appl. No.: 19/201,774

(22) Filed: May 7, 2025

Related U.S. Application Data
(60) Provisional application No. 63/643,850, filed on May 7, 2024.

(51) Int. Cl. B01L 9/06

(52) U.S. Cl. CPC B01L 9/06; B01L 2200/028; B01L 2300/021

(57) ABSTRACT

A tube rack has multiple drawers with distinct sets of tube receptacles configured to hold inserted tubes, such as tubes that store biological samples of subjects. The drawers are independently removable from an outer frame of the tube rack. Individual drawers holding particular subsets of tubes may be selectively removed from the outer frame of the tube rack, for instance during processing or testing of biological samples contained within the subsets of tubes held in the individual drawers.

### CROSS-REFERENCE TO RELATED APPLICATIONS

This application claims priority to U.S. Provisional App. No. 63/643,850, filed on May 7, 2024, which is incorporated by reference herein in its entirety.

### BACKGROUND

Many individuals rely on genetic testing and/or other diagnostic tests to identify whether they have, or are predicted to develop, various health related conditions. For example, diagnostic tests may be performed on plasma, separated from blood samples of patients or other subjects, to identify indicators of diseases.

In many cases, blood samples and/or other biological samples may be collected from subjects at first locations, such as clinician offices, hospitals, clinical trial locations, or other locations. The biological samples may also be transported to second locations, such as laboratories or other different locations, where the biological samples may be processed and/or tested.

For example, collected blood samples may be stored and/or transported in tubes. At a laboratory, the samples may be processed by manipulating the tubes. For instance, the tubes may be put into a centrifuge that spins to separate out plasma from the blood samples. Laboratory workers may then use pipettes or other equipment to manually extract the plasma, such that the extracted plasma may be further analyzed via one or more types of diagnostic tests.

### BRIEF DESCRIPTION OF THE DRAWINGS

Various aspects of the disclosed methods, devices, and systems are set forth with particularity in the appended claims. A better understanding of the features and advantages of the disclosed methods, devices, and systems will be obtained by reference to the following detailed description of illustrative embodiments and the accompanying drawings, of which:

FIG. 1 illustrates an example of a tube rack with drawers that are configured to hold tubes.

FIG. 2A and FIG. 2B show an example in which a particular drawer may be removed from the tube rack.

FIG. 3 shows an example of a process for using the tube rack for manual extraction of plasma from blood samples.

### DETAILED DESCRIPTION

Various implementations of the present disclosure relate to a tube rack that may store tubes, such as tubes containing biological samples. For example, tubes containing blood samples or other biological samples associated with patients or other subjects may be inserted into the tube rack for storage and/or transport.

In some situations, tubes of biological samples may be at least temporarily placed in a tube rack so that the tubes can be removed from the tube rack during diagnostic tests or other procedures. For example, tubes containing blood samples may be removed from a tube rack so that the tubes may be placed in a centrifuge that operates to separate plasma from other components of the blood samples. The separated plasma may then be extracted from the tubes via manual or automatic techniques, such that the plasma may be separately stored and/or tested.

However, the structures of many existing tube racks may increase chances of confusion, cross-contamination between samples from different subjects, and/or other issues. For example, some existing tube racks may hold up to forty-eight tubes. If biological samples of multiple subjects are to be processed or tested, tubes associated with multiple different subjects may be placed into the same tube rack. If each subject is associated with a set of four tubes, a tube rack with spaces for forty-eight tubes may hold tubes that are associated with up to twelve different subjects.

Accordingly, it may be difficult for laboratory workers or other users to keep track of which tubes in a tube rack are associated with which subjects. As an example, a worker intending to process a tube containing a biological sample of a particular subject may mistakenly remove and/or process a tube associated with a different subject from the tube rack. Mistakenly selecting and/or processing the wrong tube from a tube rack containing a relatively large number of tubes may also lead to cross-contamination between biological samples associated with different subjects. Similarly, it may be relatively easy for a worker to forget which tubes in a tube rack holding a relatively large number of tubes have already been processed and/or still need to be processed.

It may also be difficult and/or cumbersome to transport many existing tube racks. As an example, a laboratory worker may be assigned to manually extract plasma from a set of blood samples of a particular subject stored in tubes held in a tube rack that holds up to forty-eight tubes. However, to perform that task, the worker may need to transport the entire tube rack to a location that is closer to a centrifuge and/or manual plasma extraction equipment. Because the tube rack may store a relatively large number of tubes associated with many different subjects, transporting the entire tube rack may be inconvenient and/or increase the chances of confusion and/or cross-contamination as discussed above.

Some users have developed methods that may reduce the chances of confusion, cross-contamination, and/or other issues when relatively large tube racks are used. For example, if a laboratory worker is using a tube rack with forty-eight tube receptacles arranged in rows and columns, the worker may fill every other row with tubes and leave intervening rows empty in order to keep groups of tubes associated with different subjects separated and distinct within the tube rack. However, this may be an inefficient use of space, as half of the forty-eight tube receptacles in the tube rack may remain empty.

The tube rack described herein may address these and other concerns. For example, the tube rack may include multiple drawers that are independently removable from the tube rack. Each drawer may hold a distinct set of tubes, such as tubes that store blood samples or other biological samples. A laboratory worker or other user may process or use a desired subset of tubes, out of an overall amount of tubes, held in the tube rack by removing a particular drawer that holds that desired subset of tubes. The user may transport the removed drawer to a different location, while other tubes in other drawers remain in the tube rack. Accordingly, there may be less chance of confusion and/or cross-contamination between sets of tubes held in different drawers.

As an example, different drawers of the tube rack may hold different sets of tubes that contain biological samples of different subjects. When a worker is to process biological samples of a particular subject, the worker may remove a single drawer of the tube rack that holds a set of tubes containing the biological samples of that particular subject, while other drawers holding tubes containing biological samples of other subjects may remain in the tube rack. The worker may transport the removed drawer away from the tube rack to a location closer to a centrifuge, manual extraction equipment, and/or other equipment so that the tubes in the drawer may be more easily processed. Accordingly, because the worker may focus on processing just the subset of tubes in the removed and/or transported drawer, there may be less chance of the worker accidentally processing tubes associated with other subjects that are held in other drawers, and there may be less chance of cross-contamination between tubes associated with different subjects that are held in different drawers.

### Example Definitions

As used herein, the term “condition,” and its equivalents, may refer to the state of an individual's health. A condition may refer to a positive state (e.g., a visual acuity that is better than 20/20 vision, nonpathological hypotension, etc.), a normal state (e.g., a normal blood pressure), a negative state (e.g., a pathological condition, such as cancer), or any combination thereof.

As used herein, the term “pathological condition,” “pathology,” “disease,” and their equivalents, may refer to an abnormal anatomical, physiological, or psychological condition that reduces one or more functional abilities below a typical efficiency. As a result of a pathological condition, a subject may have an impaired function, pain, reduced life expectancy, or some other negative health consequence.

As used herein, the term “cancer,” and its equivalents, may refer to a condition of a subject in which particular cells (referred to as “cancer cells”) divide uncontrollably in the subject's body. In some cases, a cancer is characterized by a location or tissue type from which the cancer cells originated. In some examples, a cancer is characterized by a location or tissue type in which the cancer cells are located. Cancer is a type of pathological condition.

As used herein, the terms “tumor,” “neoplasm,” and their equivalents, may refer to a mass of tissue including cancer cells.

As used herein, the terms “tissue of origin,” “tissue origin,” and their equivalents, refers to a differentiated type of tissue from which cancer cells in the body of a subject began dividing uncontrollably in the subject's body.

As used herein, the terms “liquid biopsy,” “fluid biopsy,” and their equivalents, may refer to a process of obtaining a fluid sample from a subject's body. The sample, for instance, can be referred to as a “liquid biopsy sample.” Examples of fluids that are sampled from the body include blood, plasma, cerebrospinal fluid, sputum, stool, urine, lymphatic fluid, and saliva.

As used herein, the term “tissue biopsy,” and its equivalents, may refer to a process of obtaining a sample of cells from a subject's body. A tissue biopsy, in various cases, is performed by cutting a mass of cells from the subject's body. For instance, a tissue biopsy is a procedure performed by a surgeon, interventional radiologist, interventional cardiologist, or other specialized clinician. The term “tissue” or “tissue biopsy sample” can be used to refer to the sample of cells obtained using a tissue biopsy.

As used herein, the term “subject,” and its equivalents, may refer to a human or non-human animal. A subject that is receiving care from at least one care provider may be referred to as a “patient.”

As used herein, the term “clinical trial,” and its equivalents, may refer to a research study used to evaluate a hypothesis based on participation by one or more subjects. In various examples, a clinical trial can be used to assess the efficacy and/or safety of a proposed therapy. A clinical trial may be performed in furtherance of approval of a treatment by a regulatory authority (e.g., the United States Food & Drug Administration (FDA)).

### Description of Example Implementations

Various implementations of the present disclosure will now be described with reference to the accompanying Figures.

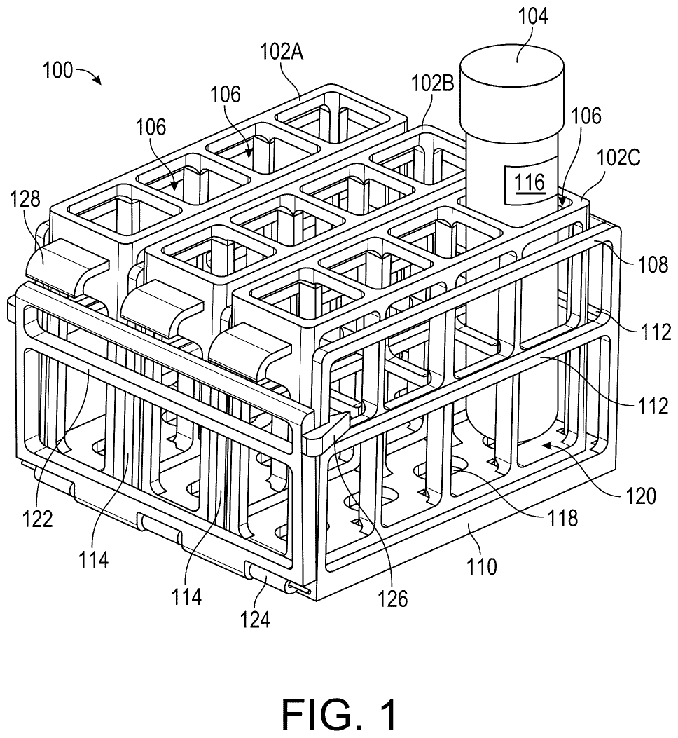

FIG. 1 illustrates an example of a tube rack 100 with drawers 102 that are configured to hold tubes 104. The tube rack 100 may be modular, and have multiple drawers 102 that are independently removable from the tube rack 100. Each drawer 102 may define a set of one or more tube receptacles 106. Tubes 104 may be inserted into and held within tube receptacles 106 of the tube rack 100, for instance during transport and/or storage of the tubes 104. Tubes 104 may also be removed from the tube receptacles 106, for instance when tubes 104 are removed so that material inside the tubes 104 can be accessed and/or used.

The tubes 104 may be centrifuge tubes, test tubes, and/or other types of tubes that may store liquids and/or other substances or materials. In some examples, the tubes 104 may be conical centrifuge tubes, such as Falcon® conical centrifuge tubes.

In some examples, the tubes 104 may store biological samples associated with subjects, such as patients, clinical trial participants, and/or other subjects. In some examples, the biological samples stored in the tubes 104 may be liquid biopsy samples obtained via liquid biopsy processes. For instance, the biological samples stored in the tubes 104 may be, or include, blood, plasma, cerebrospinal fluid, sputum, stool, urine, lymphatic fluid, saliva, or other types of biological samples. As an example, a tube 104 may store a blood sample of a subject. In some situations, plasma, serum, and/or other elements may be extracted from such a blood sample stored in a tube 104. In other examples, the biological samples stored in the tubes 104 may be tissue biopsy samples obtained via tissue biopsy processes, or other types of biological samples.

The tube rack 100 may store a set of tubes 104. In some examples, different tubes 104 and/or different subsets of tubes 104 may be associated with different subjects. For instance, different drawers 102 may respectively hold different sets of tubes 104 that store biological samples of different subjects. As an example, a first drawer 102 may hold a first set of tubes 104 containing biological samples of a first subject, while a second drawer 102 may hold a second set of tubes 104 containing biological samples of a second subject.

Each drawer 102 may be configured to hold a distinct group of tubes 104. For instance, in some examples each drawer 102 may have four tube receptacles 106, such that the tube receptacles 106 of each drawer 102 are collectively configured to hold four tubes 104 as shown in FIG. 1. In other examples, individual drawers 102 may have other numbers of tube receptacles 106, such that the drawers 102 may each be configured to hold one tube 104, two tubes 104, three tubes 104, five tubes 104, six tubes 104, or any other number of tubes 104.

The tube rack 100 may have multiple drawers 102. For instance, in some examples the tube rack 100 may have three drawers 102, such as a first drawer 102A, a second drawer 102B, and a third drawer 102C as shown in FIG. 1. However, in other examples, the tube rack 100 may have two drawers 102, four drawers 102, five drawers 102, six drawers 102, or any other number of drawers 102.

Overall, the tube rack 100 may be configured to hold up to a number of tubes 104 that is based on the number of drawers 102 and the number of tube receptacles 106 of each drawer 102. For example, in the example shown in FIG. 1 in which the tube rack 100 has three drawers 102 with four tube receptacles 106 each, the tube rack 100 may have twelve tube receptacles 106 in total. However, in other examples in which the tube rack 100 a different number of drawers 102, and/or in which individual drawers 102 have different numbers of tube receptacles 106, the tube rack 100 may have less than twelve tube receptacles 106, or more than twelve tube receptacles 106, in total. As a non-limiting example, if the tube rack 100 has twelve drawers 102 that each have four tube receptacles 106, the tube rack 100 may hold up to forty-eight tubes 104 and thereby be capable of storing a “half plate” of biological samples.

The drawers 102 of the tube rack 100 may be removably held within an outer frame 108 of the tube rack 100. The drawers 102 may be independently removable from the outer frame 108, such that individual drawers 102 may in some situations be selectively removed from the outer frame 108 as discussed further below. As an example, when a laboratory worker is to process biological samples of a particular subject, the laboratory worker may identify a particular drawer 102 that holds tubes 104 containing the biological samples of the particular subject. The laboratory worker may remove that particular drawer 102 from the outer frame 108 of the tube rack 100. The laboratory worker may also move the removed drawer 102 away from the tube rack 100, for instance to be closer to laboratory equipment that will be used to process the biological samples of the particular subject. Accordingly, because the laboratory worker may remove the particular drawer 102 that holds tubes 104 associated with the particular subject from the outer frame 108 of the tube rack 100, other drawers 102 holding tubes 104 associated with one or more other subjects may remain in the outer frame 108 of the tube rack 100. This may reduce confusion and/or reduce the likelihood of cross-contamination between biological samples of different subjects, because the laboratory worker may focus on processing the biological samples of the particular subject in the set of tubes 104 held within the drawer 102 that was removed from the outer frame 108 of the tube rack 100, while biological samples of other subjects held in other tubes 104 in other drawers 102 may remain in the outer frame 108 of the tube rack 100.

The outer frame 108 of the tube rack 100 may have a base 110 and a plurality of walls 112, which may define an interior space of the outer frame 108. The drawers 102 may be removably held and/or stored within the interior space of the outer frame 108.

The base 110 may be a substantially planar component. For example, the base 110 may be a component, such as a square component, a rectangular component, or a component having any other shape, that extends along a first plane.

The walls 112 may extend from the base 110, for instance from positions along the edges of the base 110. The walls 112 may extend along planes that are different from the first plane along which the base 110 extends. For instance, the walls 112 may extend perpendicularly from the base 110. As an example, if the base 110 rests on a horizontal surface, such as countertop or tabletop, the base 110 may be oriented along a horizontal plane, and the walls 112 may extend upward from edges of the base 110 along vertical planes.

The drawers 102 of the tube rack 100 may rest, and/or be stored, within the interior space of the outer frame 108. For example, the drawers 102 may rest on or above a surface of the base 110, between the walls 112.

In some examples, the outer frame 108 may have one or more dividers 114 that are positioned within the interior space of the outer frame 108. The dividers 114 may extend from the base 110 at positions spaced apart at intervals between opposing walls 112. Similar to the walls 112, the dividers 114 may extend along planes that are different from the first plane along which the base 110 extends. For instance, the dividers 114 may extend perpendicularly from the base 110. The dividers 114 may extend along planes that are parallel to planes along which the opposing walls 112 extend.

The walls 112 and/or the dividers 114 may define multiple sections of the interior space of the outer frame 108. For example, distinct spaces between pairs of dividers 114, and/or between walls 112 and dividers 114, may be sections of the interior space of the outer frame 108. The drawers 102 may accordingly rest, and/or be stored, within corresponding sections of the outer frame 108 defined by the walls 112 and/or the dividers 114.

In other examples, but may have other elements that may hold and/or position drawers 102 at respective sections of the interior space of the outer frame 108. Such elements may separate the drawers 102, and/or hold the drawers 102 in place, within the outer frame 108 instead of, or in addition to, dividers 114. For example, the base 110 and/or other components of the outer frame 108 may have grooves, depressions, snap-fit elements, connectors, and/or other elements that may interact with respective elements of drawers 102 to at least temporarily hold the drawers 102 in place within the outer frame 108.

As discussed above, the drawers 102 may each define a set of one or more tube receptacles 106. The tube receptacles 106 of a drawer 102 may be configured to hold tubes 104, within the drawer 102, in orientations such that length of the tubes 104 extend substantially along directions that are perpendicular to the plane of the base 110. For example, if the base 110 extends along a horizontal plane, the tube receptacles 106 of a drawer 102 may be configured to hold tubes 104 in an upright and/or vertical orientation as shown in FIG. 1.

The drawers 102 may also have dimensions such that the drawers 102 extend substantially along planes that are perpendicular to the plane of the base 110. For example, if the base 110 extends along a horizontal plane, the drawers 102 may stand substantially in an upright and/or vertical orientation as shown in FIG. 1. Multiple drawers 102 may stand, and/or be positioned, side by side within the interior space of the outer frame 108. As an example, the drawers 102 may have lengths that extend substantially across a length of the base 110, widths that extend across widths of smaller sections of the interior space of the outer frame 108, and heights that are similar to heights of the walls 112 of the outer frame 108, as shown in FIG. 1. The heights of the drawers 102 may be less than, equal to, or greater than the heights of the walls 112 of the outer frame 108. For example, as shown in FIG. 1, when a drawer 102 is held within the outer frame 108, an upper surface of the drawer 102 may be at or above top edges of the walls 112 of the outer frame 108.

The heights of the drawers 102 and/or the walls 112 may be less than lengths of the tubes 104. Accordingly, portions of tubes 104 inserted into the tube receptacles 106 of the drawers 102 may extend beyond upper surfaces of the drawers 102 and/or the walls 112. As shown in FIG. 1, because a portion of a tube 104 proximate to a cap and/or top end of the tube 104 may extend beyond upper surfaces of a drawer 102 and/or the walls 112 when the tube 104 is inserted into a tube receptable 106 of the drawer 102, an identifier 116 on that portion of the tube 104 may be unobstructed by elements of the drawer 102 and/or the outer frame 108. Accordingly, the identifier 116 proximate to the top end of the tube 104 may be left uncovered and visible at a time when the tube 104 is held by the tube rack 100. The identifier 116 may be a label, barcode, Quick Response (QR) code, physical indentation pattern, braille label, near-field communication (NFC) tag, radio frequency identification (RFID) tag, or other identifier that is part of, or is affixed to, the tube 104. The identifier 116 of the tube 104 may identify the biological sample stored within the tube 104, identify the subject associated with the biological sample stored within the tube 104, and/or indicate other information associated with the biological sample and/or the subject associated with the tube 104. Accordingly, because the identifier 116 of a tube 104 may be located on a portion of the tube 104 that extends above upper surfaces of the drawer 102 and/or the walls 112, the identifier 116 of the tube 104 may in some situations be read, scanned, and/or otherwise accessed or used without removal of the tube 104 from the drawer 102.

In some examples, portions of drawers 102 may define apertures 118, indentations, and/or other elements that may at least partially receive and/or hold bottom portions of respective tubes 104 inserted into respective tube receptacles 106. As an example, a drawer 102 may have a substantially planar bottom panel that defines apertures 118 at bottom ends of respective tube receptacles 106, as shown in FIG. 1. Accordingly, bottom ends of tubes 104, inserted into tube receptacles 106 of the drawer 102, may at least partially fit into and/or be held by corresponding apertures 118, such that the apertures 118 may help keep the tubes 104 in place and/or enhance stability of the tubes 104 within the tube receptacles 106.

In some examples, the drawers 102 and/or the outer frame 108 of the tube rack 100 may be at least partially formed by bars and/or other components that define openings 120. The openings 120 may allow the tubes 104, and/or contents of the tubes, to be at least partially visible to an observer from an exterior of the outer frame 108.

As an example, as shown in FIG. 1, a wall 112 of the outer frame 108 may be a substantially rectangular component formed by two side bars that extend from the base 110 and by one or more crossbars that span between the side bars. As another example, a drawer 102 may be formed by a substantially planar bottom panel that may define apertures 118 as discussed above, by side bars that extend from the bottom panel of the drawer at positions surrounding each tube receptacle 106, and by crossbars that connect the side bars at one or more heights. Accordingly, each tube receptacle 106 of the drawer 102 may be defined by a different set of bars. Although FIG. 1 shows an example in which bars are oriented along vertical and horizontal directions, bars of the tube rack 100 may be oriented along other directions. For instance, while the example of the tube rack 100 shown in FIG. 1 has walls 112 with a top horizontal crossbar that connects tops of side bars and a middle horizontal crossbar, in other examples a wall 112 may also or alternately have other vertical bars, bars oriented at 45 degree angles to form an “X” shape within a rectangle formed by side bars and a top crossbar, and/or any other arrangement of bars.

The openings 120 defined by bars of the drawers 102 and/or the outer frame 108 may be open, and/or may be filled with a transparent or translucent material, such as glass or an acrylic sheet. At least some of the openings 120 defined by drawers 102 may align with corresponding openings 120 defined by walls 112 and/or dividers 114 when the drawers 102 are held within the outer frame 108. Accordingly, a viewer may at least partially look through the openings 120. For instance, a viewer may look through one or more openings 120 of the tube rack 100 to view tubes 104 being held within the tube rack 100, and/or to view contents of such tubes 104, without removing the tubes 104 from the tube rack 100.

In other examples, the drawers 102 and/or the outer frame 108 of the tube rack 100 may lack openings 120 defined by bars or other components. For instance, a wall 112 of the outer frame 108 may be a solid rectangular component that does not have any openings 120, and/or a drawer 102 may be a solid component without openings 120 other than the tube receptables 106. However, in some of these examples the drawers 102 and/or the outer frame 108 may be formed from one or more transparent or translucent materials, such that portions of tubes 104 inserted into the drawers 102 are at least partially visible through the drawers 102 and/or the outer frame 108.

In some examples, at least one of the walls 112 of the outer frame 108 may be a door 122 that may be selectively moved relative to other portions of the outer frame 108. For example, one of the walls 112 may be a door 122 that connects to the base 110, or an adjacent wall 112, via at least one hinge 124 or other joint. Such hinges 124 or joints may allow the door 122 to be adjustable between orientations, such as between a vertical orientation and a horizontal orientation. For instance, a user may rotate the door 122, about an axis defined by the hinge 124 or joint, to open or close the door 122. In other examples, a door 122 may be a wall 112 that is selectively removable from the outer frame 108, for example by sliding the door 122 in and out of grooves or by otherwise connecting and disconnecting the door 122 to components of the base 110 and/or other walls 112. The outer frame 108 may have one or more latches 126, locks, or other elements that may selectively maintain the door 122 in position relative to other portions of the outer frame 108, until a user chooses to open or remove the door 122. For example, the door 122 may have one or more latches 126 that grip or connect to portions of one or more adjacent walls 112, as shown in FIG. 1.

When a user chooses to remove a drawer 102 from the outer frame 108, such as a drawer 102 holding one or more tubes 104 of biological samples of a subject of interest, the user may disconnect one or more latches 126 and/or open or remove the door 122 to create an opening on a corresponding side of the outer frame 108. For example, the user may rotate the door 122 about a hinge 124 to move the door 122 from a vertical orientation to a horizontal orientation. The user may accordingly slide the drawer 102 out from the interior space of the outer frame 108 through the opening in the outer frame 108 created by opening or removing the door 122, or by otherwise passing the drawer 102 through the opening in the outer frame 108 created by opening or removing the door 122. Similarly, the user may later pass the drawer 102 back into the interior space of the outer frame 108 via the opening created by opening or removing the door 122, and may close or replace the door 122 and/or connect one or more latches 126 to secure the door 122 and help hold the drawers 102 within the interior space of the outer frame 108.

In some examples, the outer frame 108 may have multiple doors 122. As a first example, a front wall 112 and an opposing rear wall 112 of the outer frame 108 may both be doors 122, such that either or both doors 122 may be opened or removed to assist with removal or insertion of drawers 102. As a second example, a wall 112 of the outer frame 108 may be divided into multiple doors 122 that may be independently openable or removable. For instance, a front wall 112 of the outer frame 108 may be divided into a number of different doors 122 that corresponds to the number of drawers 102. In this example, each drawer 102 may be associated with a distinct corresponding door 122 on the front wall 112, such that individual doors 122 along the front wall 112 may be opened or removed when individual corresponding drawers 102 are to be removed or inserted.

In other examples, a user may lift drawers 102 up and out of the outer frame 108 via a top opening defined by upper surface of the walls 112, and/or place drawers 102 down into the outer frame 108 via the top opening, without opening or removing a door 122. For example, although one of the walls 112 may be a door 122 that could be opened or removed, a user may choose to instead lift a drawer 102 out of the outer frame 108 without opening or removing that door 122. As another example, the outer frame 108 may lack a door 122, such that all of the walls 112 are fixed relative to the base 110. However, in this example a user may remove drawers 102 from the outer frame 108 between such walls 112, and/or insert drawers 102 into the outer frame 108 between such walls 112, via vertical motions, such as by lifting the drawers vertically upward out of the outer frame 108.

In some examples, the drawers 102 may each have one or more handles 128 that users may hold while inserting the drawers 102 into the outer frame 108, removing the drawers 102 from the outer frame 108, and/or otherwise moving the drawers 102. As an example, the drawers 102 may have handles 128 extending from front ends of the drawers 102, as shown in FIG. 1. Such handles 128 may be disposed on positions at the front ends of the drawers 102 at heights above a height of a top edge of a door 122 or other wall 112 at a corresponding front of the outer frame 108. Accordingly, the handles 128 may be above the door 122 or wall 112, such that the handles 128 do not contact the door 122 or wall 112, and do not interfere with movement of the door 122. As another example, the drawers 102 may also, or alternately, have may have handles 128 extending from rear ends of the drawers 102, and/or at other locations on the drawers 102.

In some examples, the tube rack 100 may be configured such that the drawers 102 may be held within the outer frame 108 at fixed or desired orientations. This may reduce confusion and/or reduce the chances of mixing up a desired arrangement of tubes 104 in drawers 102. As an example, in some situations tubes 104 may be inserted into the tube receptacles 106 of a drawer 102 in a particular order, for instance because a first tube 104 in a first tube receptacle 106 at the front of the drawer 102 is to be processed first, a second tube 104 in an adjacent second tube receptacle 106 of the drawer 102 is to be processed second, and so on. If the drawer 102 was mistakenly inserted into the outer frame 108 in a reversed orientation, a fourth tube in a fourth tube receptacle 106 at the rear of the drawer 102 may be positioned near a front of the outer frame 108, and thereby appear to be the first tube 104 that should be processed first.

However, to prevent drawers 102 from being inserted in a reversed or incorrect orientation, the drawers 102 may have arrows, front and back indicators, physical shapes, and/or other indicia that identify the intended correct orientation of the drawers 102 within the outer frame 108. Such indicia may assist users in ensuring that the drawers 102 are inserted into the outer frame 108 according to the intended orientation. Similarly, a user may distinguish the front end of a drawer 102 from a rear end of the drawer 102 if the drawer 102 has a front handle 128 on the front end and does not have a rear handle 128 on the rear end. If the drawer 102 does have handles 128 on opposing ends, rear handles 128 on rear ends of the drawers 102 may be visually distinct from front handles 128 on the front ends of the drawers 102. For instance, rear handles 128 may have a different shape or design than front handles 128, and/or may be located at different heights or positions on the rear ends of the drawers 102 relative to heights or positions of the handles 128 on the front ends of the drawers 102. Such differences in positions, designs, and/or other attributes between front handles 128 and rear handles 128 may allow users to visually distinguish the front ends of the drawers 102 from the rear ends of the drawers 102, and thereby assist the users in ensuring that the drawers 102 are inserted into the outer frame 108 according to an intended orientation.

In some examples, handles 128 and/or other structural components of the drawers 102, and/or corresponding structural components of the outer frame 108, may also be configured to prevent insertion of the drawers 102 into the outer frame 108 at incorrect orientations. For instance, each drawer 102 may have a protrusion that physically prevents the drawer 102 from being inserted into the outer frame 108 in an incorrect orientation. For instance, the front handle 128 may serve as the protrusion.

As an example, a front handle 128 of a drawer 102 may be disposed a height on the front end of the drawer 102 that may be above a height of a door 122 at a front of the outer frame 108, such that the front handle 128 does not impact the door 122 if the drawer 102 is inserted into the outer frame 108 at a correct orientation. However, the height of the front handle 128 may cause the front handle 128 to impact a crossbar of a rear wall 112 of the outer frame 108 positioned at that height when the drawer 102 is inserted into the outer frame in a reversed and incorrect orientation. Accordingly, the drawer 102 may not fit into the outer frame 108 in the incorrect orientation due to the height and/or position of the front handle 128, and/or the impact of the front handle 128 against the rear crossbar may signify to a user that the drawer 102 is in the incorrect orientation. Similarly, other structural components of the drawers 102 and/or the outer frame 108 may be configured to fit together when the drawers 102 are properly inserted into the outer frame 108 in correct orientations, but to not fit together and/or to prevent full insertion of the drawers 102 into the outer frame 108 when the drawers 102 are in incorrect orientations relative to the outer frame 108.

The drawers 102 and/or the outer frame 108 of the tube rack 100 may be formed from plastic, metal (e.g., stainless steel), wood, glass, acrylic, and/or any other materials. In some examples, the drawers 102 and/or the outer frame 108 of the tube rack 100 may be 3D printed components formed of ABS (Acrylonitrile Butadiene Styrene), Acrylic Styrene Acrylonitrile (ASA), Polylactic Acid (PLA), Polyethylene Terephthalate (PET), and/or other materials. In other examples, the drawers 102 and/or the outer frame 108 of the tube rack 100 may be manufactured via injection molding, machine tooling, and/or other manufacturing techniques. In some examples, the drawers 102 and/or the outer frame 108 may include one or more autoclavable materials.

In some examples, the tube rack 100 may be reusable, such that the same tube rack 100 and/or the drawers 102 of the tube rack 100 may be used to hold different sets of tubes 104 at different times. For example, the tube rack 100 may be used to hold a first set of tubes 104 at a first time, and then later be re-used to hold a second set of tubes 104 at a second time. The components of the tube rack 100, such as the drawers 102 and/or the outer frame 108, may accordingly be made of one or more materials that may be cleaned and/or sterilized between uses, for instance via water, soap, DNA-OFF and/or other cleaning solutions or substances, autoclaves, or other cleaning techniques.

In some examples, different drawers 102 may have different markings, indicia, colors, and/or other differing appearances. As discussed above, in some examples tubes 104 of biological samples of different subjects may be stored in different drawers 102 of the tube rack 100, and individual drawers 102 may be selected and removed from the tube rack 100 depending on which subject's biological samples are to be processed. Different drawers 102 may be made of differently-colored materials (e.g., different colors of plastic), or otherwise have different labels, markings, or visual appearances. In some cases, adjacent drawers 102 may have contrasting colors (e.g., red and green, blue and orange, yellow and purple, etc.), to avoid user confusion during processing. Accordingly, a user may use such visual attributes to quickly identify a specific drawer 102 that holds tubes 104 associated with a particular subject, and such visual attributes may cause a user to be less likely to confuse that drawer 102 with a different drawer 102 that holds tubes 104 associated with a different subject. Additionally, as discussed above, identifiers 116 of tubes 104 inserted into drawers 102 may extend above the drawers 102 and may be read and/or scanned without the tubes 104 being removed from the drawers 102, which may also assist users with identifying drawers 102 associated with particular subjects.

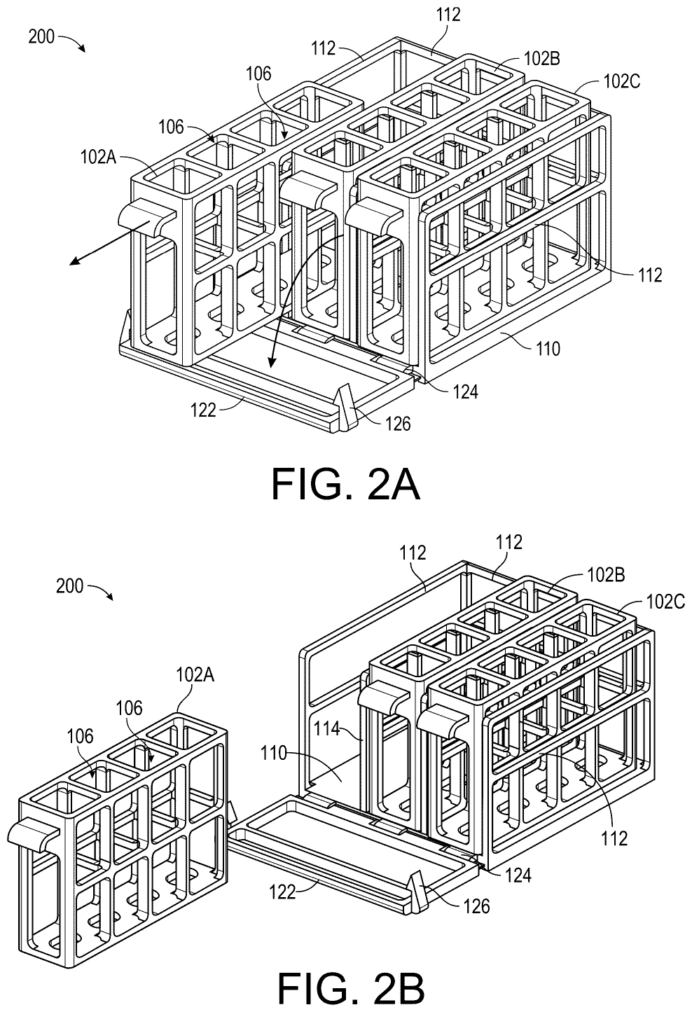

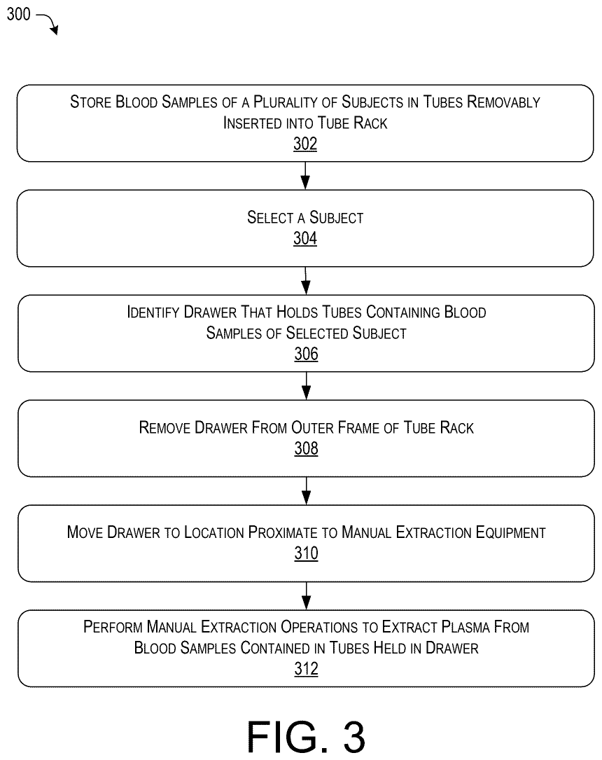

Overall, drawers 102 of the tube rack 100 may be independently selected and removed from the tube rack 100, for instance based on which sets of tubes 104 are held within the drawers 102. For example, a particular drawer 102 holding a particular set of tubes 104 that is to be processed may be removed from the tube rack 100, while other drawers 102 holding other sets of tubes 104 may remain within the tube rack 100. Removing individual drawers 102 from the tube rack 100 may allow corresponding subsets of tubes 104 to be transported and/or processed, instead of an entire set of tubes 104 held within the tube rack 100, and thereby reduce the chances of confusion, cross-contamination between different subsets of tubes 104, and/or other issues. Removal and use of individual drawers 102 selected from the tube rack 100 is discussed further below with respect to FIG. 2A, FIG. 2B, and FIG. 3.

FIG. 2A and FIG. 2B show an example 200 in which a particular drawer 102 may be removed from the tube rack 100. As discussed above, the tube rack 100 may have multiple drawers 102, such as a first drawer 102A, a second drawer 102B, and a third drawer 102C. The drawers 102 may be at least temporarily stored or held within the interior space of the outer frame 108 of the tube rack 100, for instance within sections between walls 112 and/or dividers 114. In example 200, a wall 112 of the outer frame 108 may be a door 122 that is connected to the base 110 via at least one hinge 124 and may selectively be locked in place via one or more latches 126 that connect to other walls 112.

When the door 122 is perpendicular to the base 110, for instance in a vertical orientation, and is locked in place via the one or more latches 126, the door 122 may help keep the drawers 102 held in position within the interior space of the outer frame, for example as shown in FIG. 1. However, when a user desires to remove drawer 102A, for instance to process a set of tubes 104 (not shown in FIG. 2A and FIG. 2B) held within the tube receptacles 106 of drawer 102A, the user may open the door 122 by undoing the latches 126 and rotating the door 122 about an axis defined by the one or more latches 126. For example, if the door 122 had been in a vertical orientation as shown in FIG. 1, the user may open the door 122 by moving the door 122 from the vertical orientation to a horizontal orientation as shown in FIG. 2A.

When the door 122 is opened, the user may then move drawer 102A out of the interior space of the outer frame 108, as shown in FIG. 2A and FIG. 2B. For example, the user may slide drawer 102A across the base 110, over the opened door 122, and out of an opening in the outer frame 108 that was created by the opening of the door 122.

The user may transport the removed drawer 102A to a different location away from the rest of the tube rack 100. For example, while the outer frame 108, drawer 102B, and drawer 102C may remain at one location, the user may transport removed drawer 102A to another location, such as a location closer to laboratory equipment. The user may accordingly process tubes 104 held in drawer 102A, for example by removing the tubes 104 from drawer 102A and performing tests or other procedures on biological samples contained in those tubes 104.

When the user is done with drawer 102A, the user may return drawer 102A to the outer frame 108 by sliding the drawer 102A back into the corresponding section of the outer frame 108. In some cases, the user may choose to remove a different drawer 102, such as drawer 102B or drawer 102C, from the outer frame 108. In other cases, the user may choose to close and latch the door 122 to secure the drawers 102 within the outer frame 108.

FIG. 3 shows an example of a process 300 for using the tube rack 100 for manual extraction of plasma from blood samples. At block 302, blood samples of a plurality of subjects may be stored in tubes 104 that are removably inserted into the tube rack 100. For example, when blood is drawn from a subject, the blood may be stored in one or more tubes 104. Tubes 104 containing the blood samples taken from multiple subjects may be inserted into tube receptacles 106 of drawers 102 of the tube rack 100. Accordingly, the tube receptacles 106 of the drawers 102 of the tube rack 100 may receive the tubes 104 at block 302.

As described herein, the tube rack 100 may have multiple drawers 102. The drawers 102 may be independently removable from the outer frame 108 of the tube rack 100. Different drawers 102 may be used to store different sets of tubes 104 that are respectively associated with different subjects. For example, a first set of tubes 104 containing blood samples of a first subject may be stored in a first drawer 102 of the tube rack 100, while a second set of tubes 104 containing blood samples of a second subject may be stored in a second drawer 102 of the tube rack 100.

At block 304, a particular subject may be selected from among the plurality of subjects whose blood samples were stored in the tube rack 100 at block 302. As example, if the tube rack 100 stores tubes 104 containing blood samples of three different subjects, a user may select one of those three subjects at block 304.

At block 306, a particular drawer 102 may be selected, from among the multiple drawers 102 of the tube rack 100, that is associated with the subject selected at block 304. In some examples, the tubes 104 inserted into the tube receptacles 106 of the drawers 102 may have heights that are greater than heights of the drawers 102, such that top ends of the tubes 104 extend above and beyond upper surfaces of the drawers 102. Accordingly, identifiers 116 proximate to the top ends of the tubes 104 may be positioned above, and be unobscured by, the drawers 102 and/or other elements of the tube rack 100. The identifiers 116 may be barcodes or other indicia that indicate the subjects associated with the tubes 104, and/or that indicate other information associated with the blood samples stored within the tubes 104. Accordingly, in these examples, a user may read or scan the identifiers 116 of the tubes 104, without removing the tubes 104 from the tube rack 100, to identify which of the drawers 102 holds tubes 104 associated with the subject selected at block 304. In other examples, a user may also or alternately view portions of the tubes 104 through openings 120 in the outer frame 108 and/or the drawers 102, to view identifying information on or in the tubes 104 that may be indicative of which drawer 102 is associated with the subject selected at block 304. In other examples, a user may also or alternately use labels, colors, or other indicia associated with the drawers 102 to identify the particular drawer 102 that is associated with the subject selected at block 304.

At block 308, the drawer 102 selected at block 306 may be removed from the outer frame 108 of the tube rack 100. For instance, in some examples, a user may open a door 122 of the outer frame 108, and then slide out or otherwise remove the selected drawer 102 from the outer frame 108 as shown in FIG. 2A and FIG. 2B. In other examples, a user may lift the selected drawer 102 out of the outer frame 108 without opening a door 122.

At block 310, the drawer 102 removed from the outer frame 108 at block 308 may be moved to a location proximate to manual extraction equipment. For example, if the tube rack 100 is located in a laboratory, the tube rack 100 may be on a table at a first location in the laboratory, but a user may move the removed drawer 102 from the table at the first location to a different table or other surface at a second location in the laboratory that is close to a centrifuge, pipettes, and/or other equipment configured to be used to manually extract plasma from blood samples. Accordingly, while tubes 104 containing blood samples of other subjects that are stored in other drawers 102 of the tube rack 100 may remain at the first location, the drawer 102 that contains blood samples of the selected subject that was removed from the outer frame 108 at block 308 may be moved to the second location in the laboratory that is nearer to the manual extraction equipment.

At block 312, one or more manual extraction operations may be performed to extract plasma from the set of blood samples contained in the tubes 104 held in the drawer 102 removed at block 308. For example, a user may remove the tubes 104 from the drawer 102, place the tubes 104 in a centrifuge, activate the centrifuge to separate plasma from other components of the blood samples, and then use pipettes to extract the separated plasma.

Accordingly, by processing the set of tubes 104 held in the held in the drawer 102 removed at block 308, which corresponds to the subject selected at block 304, a user may manually extract plasma from the set of blood samples of that selected subject. Blood samples of other subjects may remain in tubes 104 held in other drawers 102 that are still in the tube rack 100, at a different location within the laboratory. Because a user may focus on processing the blood samples of the subject that are contained in the tubes 104 held in the removed drawer 102, instead of other blood samples of other subjects contained in other tubes 104 in other drawers 102 still held in the tube rack 100, there may be a reduced risk of the user accidentally processing the other blood samples, and/or switching or cross-contaminating blood samples of different subjects.

When the manual extraction operations performed at block 312, using the tubes 104 held in the drawer 102 removed at block 308, are complete, that drawer 102 may be returned to the outer frame 108. In some examples, a different subject may then be selected at block 304, a different corresponding drawer may be selected at block 306, the different drawer may be removed at block 308 and moved at block 310, and manual extraction operations may performed in association with a different set of tubes 104 in the different drawer at block 312. In other examples, a user may instead choose to stop working with the set of tubes 104 held in the tube rack 100, and may close a door 122 or otherwise secure the drawers 102 within the outer frame 108.

Although the example process 300 shown in FIG. 3 involves the use of the tube rack 100 during operations to manually extract of plasma from blood samples stored in tubes 104 held within the tube rack 100, in other examples the tube rack 100 may be used similarly during other types of operations and/or other types of biological samples stored in tubes 104 held within the tube rack 100. For example, other biological samples of subjects, such as samples of cerebrospinal fluid, sputum, stool, urine, lymphatic fluid, saliva, or other substances, may be contained in tubes 104. Sets of such tubes 104 associated with particular subjects may be inserted into corresponding drawers 102 of the tube rack 100. Accordingly, when laboratory worker or other user works on processing biological samples of a particular subject, for instance to process or test the biological samples via manual and/or automatic operations, the user may identify one of the drawers 102 in the tube rack 100 that holds tubes 104 containing the biological samples of that particular subject. The user may remove that drawer 102 from the outer frame 108, and may move that drawer 102 to another location that is closer to where processing or testing is to be performed. For instance, the user may move the removed drawer 102 closer to laboratory equipment and/or testing equipment, while other drawers 102 holding tubes 104 containing biological samples of other subjects remain in the outer frame 108 of the tube rack 100. The user may accordingly process the biological samples of the particular subject contained in the tubes 104 that are or were held in the removed drawer 102, while drawers 102 holding other tubes 104 associated with other subjects may remain in the outer frame 108 of the tube rack 100.

### Example Clauses

1. A tube rack, comprising: an outer frame including: a base; a plurality of walls extending from the base, wherein the plurality of walls defines an interior space of the outer frame; and a plurality of dividers that: extend from the base at positions spaced at intervals between opposing walls of the plurality of walls, and define a plurality of sections of the tube rack within the interior space; and a plurality of drawers configured to stand perpendicular to the base and side by side on the base within corresponding sections of the plurality of sections, wherein individual drawers, of the plurality of drawers, comprise drawer frames that: are independently removable from the outer frame, and define a plurality of tube receptacles configured to hold removable tubes in an upright orientation, the removable tubes being configured to store biological samples.
2. The tube rack of clause 1, wherein the biological samples comprise patient blood samples taken for manual extraction of plasma.
3. The tube rack of clauses 1 or 2, wherein different drawers, of the plurality of drawers, respectively store different sets of biological samples that are associated with different subjects.
4. The tube rack of any of clauses 1 to 3, wherein: the drawer frames have a first height that is less than a second height of the removable tubes, and at a time at which a removable tube is inserted into a tube receptacle of an individual drawer, at least one of a barcode, a subject identifier, or other identifier positioned proximate to a top end of the removable tube extends above, and is unobstructed by, a top portion of the individual drawer.
5. A tube rack, comprising: an outer frame including: a base; and a plurality of walls extending from the base, wherein the plurality of walls defines an interior space of the outer frame; and a plurality of drawers configured to rest on the base within the interior space, wherein individual drawers, of the plurality of drawers, comprise drawer frames that: are independently removable from the outer frame, and define a plurality of tube receptacles configured to hold removable tubes positioned in an upright orientation.
6. The tube rack of clause 5, wherein the plurality of tube receptacles defined by an individual drawer frame of an individual drawer, of the plurality of drawers, are configured to hold a set of removeable tubes that store biological samples of an individual subject.
7. The tube rack of clause 6, wherein the biological samples comprise at least one of blood, plasma, cerebrospinal fluid, sputum, stool, urine, lymphatic fluid, or saliva.
8. The tube rack of clause 6, wherein the biological samples comprise manual extraction samples.
9. The tube rack of clause 6, wherein different drawers, of the plurality of drawers, are configured to hold different corresponding sets of the removable tubes that store sets of biological samples of different subjects.
10. The tube rack of any of clauses 5 to 9, wherein the plurality of tube receptacles, defined by an individual drawer frame of an individual drawer, comprise four tube receptacles configured to collectively hold four of the removable tubes.
11. The tube rack of any of clauses 5 to 10, wherein the removable tubes comprise centrifuge tubes.
12. The tube rack of clause 11, wherein the centrifuge tubes are conical centrifuge tubes.
13. The tube rack of any of clauses 5 to 12, wherein the removable tubes comprise test tubes.
14. The tube rack of any of clauses 5 to 13, wherein: the drawer frames have a first height that is less than a second height of the removable tubes, and at a time at which a removable tube is inserted into a tube receptacle of an individual drawer, a top end of the removable tube extends above a top portion of the individual drawer.
15. The tube rack of clause 14, wherein at the time at which the removable tube is inserted into the tube receptacle of the individual drawer, at least one of a barcode, a subject identifier, or other identifier, positioned on the removable tube proximate to the top end, extends above and is unobstructed by the top portion of the individual drawer.
16. The tube rack of any of clauses 5 to 15, wherein the outer frame further comprises a plurality of dividers that: extend from the base at positions spaced at intervals between opposing walls of the plurality of walls, and define a plurality of sections of the tube rack that correspond to the plurality of drawers.
17. The tube rack of any of clauses 5 to 16, wherein: the outer frame and the plurality of drawers comprise bars defining openings, and at least some of the openings of the outer frame and the plurality of drawers are aligned to permit contents of the plurality of tube receptacles to be visible from an exterior of the outer frame.
18. The tube rack of any of clauses 5 to 17, wherein at least one wall, of the plurality of walls of the outer frame, comprises a door connected to the base or an adjacent wall via a hinge.
19. The tube rack of clause 18, wherein the door is selectively adjustable, via the hinge, from a vertical orientation to a horizontal orientation.
20. The tube rack of clause 19, wherein the individual drawers are independently removable from the outer frame, by sliding the individual drawers along the base out of the outer frame, at times at which the door is in the horizontal orientation.
21. The tube rack of clause 19, wherein the door comprises a latch configured to selectively maintain the door in the vertical orientation.
22. The tube rack of clause 18, wherein the at least one wall comprises a plurality of doors, and individual doors, of the plurality of doors, correspond to the individual drawers.
23. The tube rack of any of clauses 5 to 22, wherein the individual drawers are independently removable from the outer frame, by moving the individual drawers vertically upward out of the interior space of the tube rack.
24. The tube rack of any of clauses 5 to 23, wherein an individual drawer, of the plurality of drawers, comprises at least one handle.
25. The tube rack of clause 24, wherein the individual drawer comprises: a first handle on a front end of the individual drawer; and a second handle on a rear end of the individual drawer.
26. The tube rack of clause 25, wherein at least one of positions or designs of the first handle and the second handle have differences that visually differentiates the front end relative to the rear end.
27. The tube rack of any of clauses 5 to 26, wherein a front end of an individual drawer, of the plurality of drawers, has a different structure than an opposing rear end of the individual drawer.
28. The tube rack of clause 27, wherein the different structure prevents insertion of the individual drawer into the outer frame at an incorrect orientation.
29. The tube rack of any of clauses 5 to 28, wherein different drawers, of the plurality of drawers, have different colors or markings that differentiate the different drawers.
30. The tube rack of any of clauses 5 to 29, wherein an individual drawer, of the plurality of drawers, comprises a bottom panel having indentations or defining apertures that correspond with the plurality of tube receptacles and are configured to receive bottom ends of the removable tubes.
31. A method, comprising: storing blood samples of a plurality of subjects in tubes removably inserted into a tube rack, wherein the tube rack comprises: an outer frame having a base and a plurality of walls extending from the base, the plurality of walls defining an interior space of the outer frame; and a plurality of drawers configured to rest on the base within the interior space of the outer frame, wherein individual drawers, of the plurality of drawers, comprise drawer frames that: are independently removable from the outer frame, and define a plurality of tube receptacles configured to hold the tubes; selecting a subject, of the plurality of subjects; identifying an individual drawer, of the plurality of drawers, that holds a set of the tubes that stores a set of the blood samples of the selected subject; removing the individual drawer from the outer frame; moving the individual drawer to a location, apart from the outer frame, proximate to manual extraction equipment; and performing manual extraction operations, using the set of the blood samples of the selected subject stored in the set of the tubes held by the individual drawer, to extract plasma from the set of the blood samples.
32. The method of clause 31, wherein: the drawer frames have a first height that is less than a second height of the tubes, and at a time at which a tube is held in a tube receptacle of the individual drawer, at least one of a barcode, a subject identifier, or other identifier positioned proximate to a top end of the tube extends above, and is unobstructed by, a top portion of the individual drawer.
33. The method of clause 32, wherein identifying the individual drawer, that holds the set of the tubes that stores the set of the blood samples of the selected subject, comprises identifying of the set of the tubes based on the at least one of the barcode, the subject identifier, or the other identifier at the time the tube is held in the tube receptacle.

### CONCLUSION

All publications, patents, and patent applications mentioned in this specification are herein incorporated by reference in their entirety to the same extent as if each individual publication, patent, or patent application was specifically and individually indicated to be incorporated by reference in its entirety. In the event of a conflict between a term herein and a term in an incorporated reference, the term herein controls.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing implementations of the disclosure in diverse forms thereof.

As will be understood by one of ordinary skill in the art, each implementation disclosed herein can comprise, consist essentially of or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the implementation to the specified elements, steps, ingredients or components and to those that do not materially affect the implementation. As used herein, the term “based on” is equivalent to “based at least partly on,” unless otherwise specified.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e., denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the,” and similar referents used in the context of describing implementations (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate implementations of the disclosure and does not pose a limitation on the scope of the disclosure. No language in the specification should be construed as indicating any non-claimed element essential to the practice of implementations of the disclosure.

Groupings of alternative elements or implementations disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain implementations are described herein, including the best mode known to the inventors for carrying out implementations of the disclosure. Of course, variations on these described implementations will become apparent to those of ordinary skill in the art upon reading the foregoing description. The inventor expects skilled artisans to employ such variations as appropriate, and the inventors intend for implementations to be practiced otherwise than specifically described herein. Accordingly, the scope of this disclosure includes all modifications and equivalents of the subject matter recited in the claims appended hereto as permitted by applicable law. Moreover, any combination of the above-described elements in all possible variations thereof is encompassed by implementations of the disclosure unless otherwise indicated herein or otherwise clearly contradicted by context.

What is claimed is:

1. A tube rack, comprising:
an outer frame including:
a base;
a plurality of walls extending from the base, wherein the plurality of walls defines an interior space of the outer frame; and
a plurality of dividers that:
extend from the base at positions spaced at intervals between opposing walls of the plurality of walls, and
define a plurality of sections of the tube rack within the interior space; and
a plurality of drawers configured to stand perpendicular to the base and side by side on the base within corresponding sections of the plurality of sections,
wherein individual drawers, of the plurality of drawers, comprise drawer frames that:
are independently removable from the outer frame, and
define a plurality of tube receptacles configured to hold removable tubes in an upright orientation, the removable tubes being configured to store biological samples.

2. The tube rack of claim 1, wherein the biological samples comprise patient blood samples taken for manual extraction of plasma.

3. The tube rack of claim 1, wherein different drawers, of the plurality of drawers, respectively store different sets of biological samples that are associated with different subjects.

4. The tube rack of claim 1, wherein:
the drawer frames have a first height that is less than a second height of the removable tubes, and
at a time at which a removable tube is inserted into a tube receptacle of an individual drawer, at least one of a barcode, a subject identifier, or other identifier positioned proximate to a top end of the removable tube extends above, and is unobstructed by, a top portion of the individual drawer.

5. A tube rack, comprising:
an outer frame including:
a base; and
a plurality of walls extending from the base, wherein the plurality of walls defines an interior space of the outer frame; and
a plurality of drawers configured to rest on the base within the interior space, wherein individual drawers, of the plurality of drawers, comprise drawer frames that:
are independently removable from the outer frame, and
define a plurality of tube receptacles configured to hold removable tubes positioned in an upright orientation.

6. The tube rack of claim 5, wherein the plurality of tube receptacles defined by an individual drawer frame of an individual drawer, of the plurality of drawers, are configured to hold a set of removeable tubes that store biological samples of an individual subject.

7. The tube rack of claim 5, wherein:
the drawer frames have a first height that is less than a second height of the removable tubes, and
at a time at which a removable tube is inserted into a tube receptacle of an individual drawer, a top end of the removable tube extends above a top portion of the individual drawer.

8. The tube rack of claim 7, wherein at the time at which the removable tube is inserted into the tube receptacle of the individual drawer, at least one of a barcode, a subject identifier, or other identifier, positioned on the removable tube proximate to the top end, extends above and is unobstructed by the top portion of the individual drawer.

9. The tube rack of claim 5, wherein the outer frame further comprises a plurality of dividers that:
extend from the base at positions spaced at intervals between opposing walls of the plurality of walls, and
define a plurality of sections of the tube rack that correspond to the plurality of drawers.

10. The tube rack of claim 5, wherein:
the outer frame and the plurality of drawers comprise bars defining openings, and
at least some of the openings of the outer frame and the plurality of drawers are aligned to permit contents of the plurality of tube receptacles to be visible from an exterior of the outer frame.

11. The tube rack of claim 5, wherein:
at least one wall, of the plurality of walls of the outer frame, comprises a door connected to the base or an adjacent wall via a hinge;
the door is selectively adjustable, via the hinge, from a first orientation to a second orientation; and
the individual drawers are independently removable from the outer frame, by sliding the individual drawers along the base out of the outer frame, at times at which the door is in the second orientation.

12. The tube rack of claim 11, wherein the door comprises a latch configured to selectively maintain the door in the first orientation.

13. The tube rack of claim 11, wherein the at least one wall comprises a plurality of doors, and individual doors, of the plurality of doors, correspond to the individual drawers.

14. The tube rack of claim 5, wherein an individual drawer, of the plurality of drawers, comprises at least one handle.

15. The tube rack of claim 5, wherein a front end of an individual drawer, of the plurality of drawers, has a different structure than an opposing rear end of the individual drawer.

16. The tube rack of claim 15, wherein the different structure prevents insertion of the individual drawer into the outer frame at an incorrect orientation.

17. The tube rack of claim 5, wherein an individual drawer, of the plurality of drawers, comprises a bottom panel having indentations or defining apertures that correspond with the plurality of tube receptacles and are configured to receive bottom ends of the removable tubes.

18. A method, comprising:
storing blood samples of a plurality of subjects in tubes removably inserted into a tube rack, wherein the tube rack comprises:
an outer frame having a base and a plurality of walls extending from the base, the plurality of walls defining an interior space of the outer frame; and
a plurality of drawers configured to rest on the base within the interior space of the outer frame, wherein individual drawers, of the plurality of drawers, comprise drawer frames that:
are independently removable from the outer frame, and
define a plurality of tube receptacles configured to hold the tubes;
selecting a subject, of the plurality of subjects;
identifying an individual drawer, of the plurality of drawers, that holds a set of the tubes that stores a set of the blood samples of the selected subject;
removing the individual drawer from the outer frame;
moving the individual drawer to a location, apart from the outer frame, proximate to manual extraction equipment; and
performing manual extraction operations, using the set of the blood samples of the selected subject stored in the set of the tubes held by the individual drawer, to extract plasma from the set of the blood samples.

19. The method of claim 18, wherein:
the drawer frames have a first height that is less than a second height of the tubes, and
at a time at which a tube is held in a tube receptacle of the individual drawer, at least one of a barcode, a subject identifier, or other identifier positioned proximate to a top end of the tube extends above, and is unobstructed by, a top portion of the individual drawer.

20. The method of claim 19, wherein identifying the individual drawer, that holds the set of the tubes that stores the set of the blood samples of the selected subject, comprises identifying of the set of the tubes based on the at least one of the barcode, the subject identifier, or the other identifier at the time the tube is held in the tube receptacle.
